(19) United States
(12) Patent Application Publication
(10) Pub. No.: US 2015/0186859 A1
(43) Pub. Date: Jul. 2, 2015

(54) Electronic Medical Record and Payment Card

(71) Applicants: Kimberly Dunn, Houston, TX (US); Adinarayana Kadapa, Houston, TX (US); Ira Jay Stowers, Garland, TX (US); David Dodson, Houston, TX (US)

(72) Inventors: Kimberly Dunn, Houston, TX (US); Adinarayana Kadapa, Houston, TX (US); Ira Jay Stowers, Garland, TX (US); David Dodson, Houston, TX (US)

(21) Appl. No.: 14/588,251

(22) Filed: Dec. 31, 2014

Related U.S. Application Data
(60) Provisional application No. 61/922,286, filed on Dec. 31, 2013.

(51) Int. Cl. G06Q 20/14; G06Q 30/06; G06Q 20/32; G06Q 50/22; G06F 19/00; G06Q 20/22

(52) U.S. Cl. CPC G06Q 20/14; G06F 19/322; G06Q 20/227; G06Q 20/322; G06Q 50/22; G06Q 30/0623

(57) ABSTRACT

A method for integrating patient data and patient's financial data for point of service payment contains a patient account and a healthcare provider account. The patient or their designee submits personal information, medical history, and payment information onto at least one secure server through the patient account. The personal information, the medical history, and the payment information are embedded onto a physical access card with at least one information retrieval point. Both the patient account and the healthcare provider account read the information retrieval point in order to access the personal information, medical history, and payment information. The healthcare provider account can view and edit the medical history of the patient account upon rendering services to the patient account. The patient account is financially charged for the services provided by the healthcare provider. In order to do so, the payment information is utilized.

The current application claims a priority to the U.S. Provisional Patent application Ser. No. 61/922,286 filed on Dec. 31, 2013.

### FIELD OF THE INVENTION

The present invention relates generally to a process/method for information management. More specifically, the present invention is a process/method for a card to integrate patient clinical and financial data for point of service payment.

### BACKGROUND OF THE INVENTION

Improvements in technology have resulted in many individuals completing payments through electronic payment cards. These electronic cards can be either debit cards or credit cards. These electronic cards are also utilized when providing different services, such as health services. Usually, a patient will have a card for medical insurance, vision insurance, and dental insurance. Having to carry multiple cards for health insurance and electronic medical records along with electronic payment cards can be a hassle.

A significant disadvantage with the existing health care system is the lack of management standards for clinical or financial transactions. The existing system requires the patient to carry all necessary documents at point of care. Such requirements can be stressful for a patient who has a long history of medical treatments. Therefore, it is clearly evident that the health care system requires a method to directly access a patient's medical history conveniently. As an example, if an emergency worker treats the patient, the emergency worker should have the ability to access the patient's medical records in order to diagnose the patient's situation.

Another disadvantage of the existing health care system is the time consuming nature of processing payments. More specifically, with the existing system the healthcare provider is not paid at the point of care. Delayed financial transactions are disadvantageous to both the patient and the healthcare provider.

The objective of the present invention is to address the aforementioned issues. More specifically, the present invention introduces an electronic access card and software which is used to complete all services related to healthcare delivery and all payments related to the payment of the healthcare services. The present invention also allows the patient to store vital information of his or her medical history on the electronic access card. More specifically, the present invention allows a healthcare provider to access the medical records and the clinical records of a patient through the electronic access card. In order to do so, the electronic access card contains an access point such as a personal quick response code. Furthermore, the present invention allows the healthcare provider to be paid in an expedited manner at the point of service. In order to do so, the electronic access card provides management of financial information, and integrates financial data for healthcare payment (patient and payer—e.g. medical flexible spending account (FSA)/Credit card/Health Service Account (HSA)/payer, employer) with instructions for information management for point of service payment. The personal quick response code previously used to access the medical records, or a different access point can be utilized in order to process the financial transactions.

### BRIEF DESCRIPTION OF THE DRAWINGS

FIG. 1 is a flowchart illustrating the basic overall method of the present invention.

FIG. 2 is another flowchart illustrating the basic overall method of the present invention.

FIG. 3 is a flowchart illustrating the basic overall method used to pay off the invoice, wherein the patient account uses the healthcare payer account and/or the direct payment account to pay off the invoice.

FIG. 4 is a flowchart illustrating the basic overall method used to pay off the invoice, wherein only the direct payment method is available.

FIG. 5 is a flowchart illustrating the basic overall method used to contact a medical professional.

### DETAIL DESCRIPTIONS OF THE INVENTION

All illustrations of the drawings are for the purpose of describing selected versions of the present invention and are not intended to limit the scope of the present invention.

The present invention is a method for keeping track of a patient's medical records, clinical records, and financial information related to medical billing. More specifically, the present invention allows the patient or their designee, or a healthcare provider to conveniently access the medical history of the patient. The present invention eliminates the need to have individual documents for medical records, clinical records, and financial information related to medical billing.

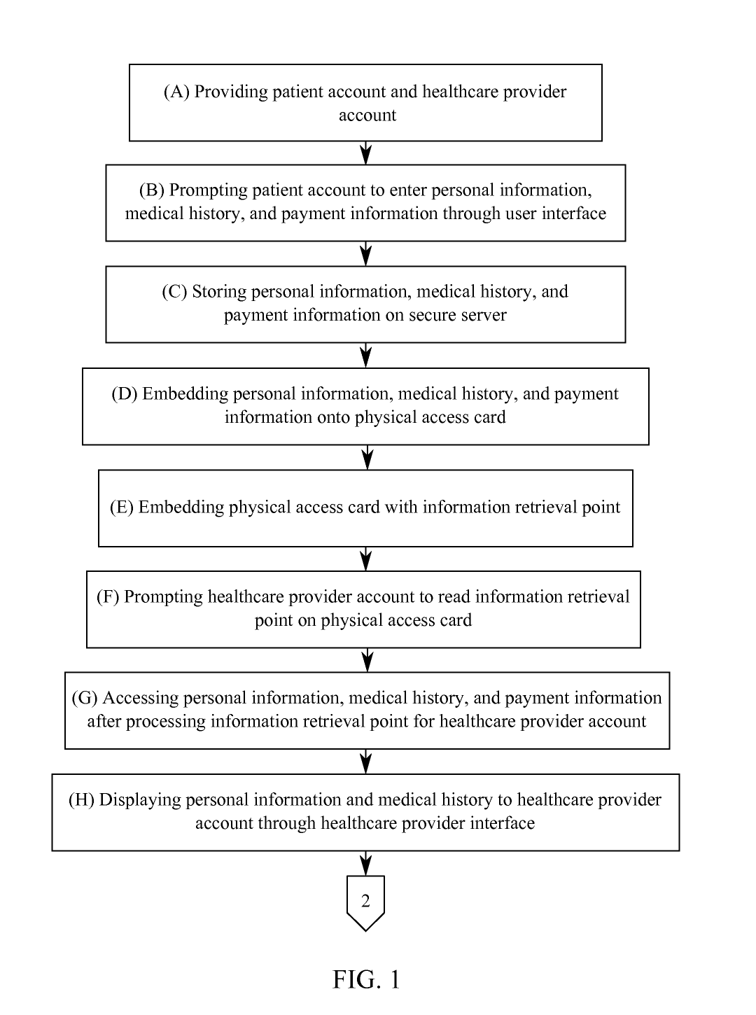

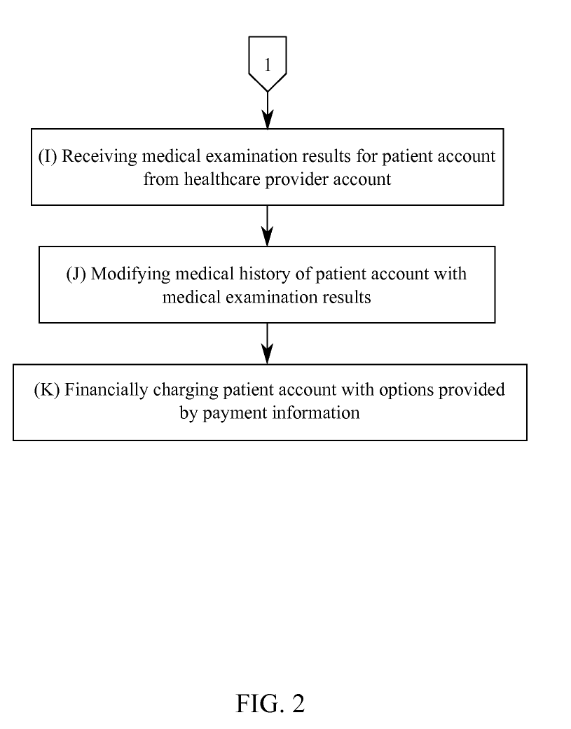

FIG. 1 and FIG. 2, illustrate the basic overall process of the present invention. As illustrated, the present invention provides a patient account for a patient. The patient or their designee updates and views medical records, clinical records, and all other medical information related to the patient through the patient account. Similar to the patient account, the present invention provides a healthcare provider account for a healthcare provider. The healthcare provider utilizes the healthcare provider account to update or view the medical history of the patient.

When utilizing the present invention, the patient or their designee initiates the process by uploading necessary information. More specifically, the present invention prompts the patient account to enter personal information, medical history, and payment information through the patient account. In doing so, the patient account utilizes a user interface which can be, but is not limited to, a mobile phone or a computer. The personal information is required to identify the patient from other patients utilizing the present invention. The personal information can include, but is not limited to, name, address, and contact information. After uploading personal information, the patient or their designee uploads medical records, clinical records, medications, and any other related information as the medical history. The medical history allows the patient or their designee to keep track of a variety of documents conveniently. Next, the patient or their designee enters the payment information. The payment information can include, but is not limited to, a credit/debit card number, a bank account number, healthcare payer information, and employer information. The present invention utilizes the payment information when financially charging the patient for services provided by the healthcare provider.

When the patient account enters the personal information, the medical history, and the payment information, the present invention stores the personal information, the medical history, and the payment information on at least one secure server. The secure server is accessible by both the patient account and the healthcare provider account. As a result, the patient or their designee can use the patient account to edit any of the existing information or upload new information by accessing the secure server. The secure server also allows the healthcare provider account to access the personal information, the medical history, and the payment information of the patient account when providing services to the patient account. More specifically, the healthcare provider account can either view the medical history or update information in the medical history. Convenient access to the medical history is beneficial to the patient or their designee in times of an emergency. Likewise, it is also beneficial to the healthcare provider in order to be knowledgeable about the patient's medical history prior to diagnosing a condition.

In order to provide an added level of convenience, the present invention embeds the personal information, the medical history, and the payment information onto a physical access card. Since all information related to the patient is embedded onto the physical card, the need to carry multiple health insurance cards and multiple medical or clinical records is eliminated. In the preferred embodiment of the present invention, the physical access card has a structure similar to a credit card. However, in another embodiment of the present invention, the physical access card can vary in size and shape. The physical access card is embedded with at least one information retrieval point which allows the patient account and the healthcare provider account to directly access the personal information, the medical history, and the payment information of the patient account which is stored on the secure server. However, in another embodiment of the present invention, the physical access card can be embedded with multiple information retrieval points. The information retrieval point can be, but is not limited to, a quick response code (QR code) and/or a magnetic strip. Similar to existing electronic payment cards, the QR code and/or the magnetic strip is printed on the physical access card. In another embodiment of the present invention, in which multiple information retrieval points are utilized, the QR code or the magnetic strip can be used to access the medical history and the personal information. Similarly, the magnetic strip or the QR code can be utilized to access the payment information. Having multiple information retrieval points is especially beneficial if the personal information, the medical history, and the payment information are distributed among multiple secure servers. However, in another embodiment of the present invention, the QR code or the magnetic strip can be utilized to access the personal information, the medical history, and the payment information simultaneously.

The patient or their designee can utilize the physical access card to directly access and edit the personal information, the medical history, and the payment information. In doing so, the patient account utilizes the user interface. The user interface can be, but is not limited to, a mobile application. In accessing the personal information, the medical history, and the payment information, the patient account is initially prompted to read the information retrieval point on the physical access card. When utilizing the mobile application, the patient account scans the information retrieval point with the mobile application. In other instances where the patient account utilizes a different user interface such as a computer, a numerical code is utilized as the information retrieval point, and is entered through the computer to access the personal information, the medical history, and the payment information. The numerical number of the information retrieval point is unique from one physical access card to another. After processing the information retrieval point, the patient account accesses their personal information, the medical history, and the payment information stored on the secure server. If the patient account is using the mobile application, the personal information, the medical history, and the payment information are displayed through the mobile application. On any other instance, the personal information, the medical history, and the payment information are displayed on the user interface.

In addition to the details regarding the patient, the personal information also includes a list of contacts. As illustrated in FIG. 6, the list of contacts includes contact information for the medical professionals associated with the patient account. The list of contacts allows the patient account to contact a desired medical professional conveniently. When the information retrieval point is processed and the personal information is displayed, the list of contacts is also displayed to the patient account. Displaying the list of contacts is especially beneficial in times of urgency. As an example, if an emergency worker or the designee of the patient reads the physical access card of the patient account, the list of contacts is beneficial in order to treat the patient or to contact the patient's regular practitioners. In order to establish a line of communication between the patient account and the medical professional, the present invention primarily prompts the patient account to select a medical professional from the list of contacts. When the desired medical professional is selected, the present invention establishes the line of communication between the patient account and the medical professional. The line of communication can be, but is not limited to, a phone call or an email notification.

Similar to the patient account, the healthcare provider account can also access the personal information, the medical history, and the payment information of the patient account. In order to do so, the healthcare provider account is prompted to read the information retrieval point on the physical access card through a healthcare provider interface. When the healthcare provider interface is the mobile application, the information retrieval point is scanned with the mobile application. When the healthcare provider interface is not the mobile application, the healthcare provider account enters the numerical code of the information retrieval point. Upon successfully processing the information retrieval point, the healthcare provider account accesses the personal information, the medical history, and the payment information of the patient account. When the present invention grants access to the healthcare provider account, the personal information, and the medical history, of the patient account are displayed on either the mobile application or the healthcare provider interface. However, in another embodiment of the present invention the payment information can also be displayed along with the personal information and the medical history. As a result, the healthcare provider account can proceed to edit or update the medical history of the patient account. The medical examination results for the patient account can be, but is not limited to, updates to medical records, updates to clinical information, or updates to medications. The present invention receives the medical examination results for the patient account from the healthcare provider account and modifies the medical history of the patient account on the secure server with the medical examination results.

The present invention provides a healthcare payer account to financially charge the patient account for the services provided by the healthcare provider account. The healthcare payer account can relate to, but is not limited to, a health insurance company, or an employer. In general, the healthcare payer account provides complete financial funding or partial financial funding for services received by the patient account. As mentioned before, the services provided can vary from updates to the medical records, updates to the clinical records, or updates to the medications of the patient account. In order to complete the financial charges, the payment information includes an association between the patient account and the healthcare payer account. Additionally, the present invention provides at least one direct payment method. Each of the direct payment methods are included in the payment information provided by the patient account, such that the patient account can utilize the physical access card as an electronic payment card. In particular, the direct payment method allows the patient account to use the physical access card as a credit card or a debit card when purchasing services from the healthcare provider account.

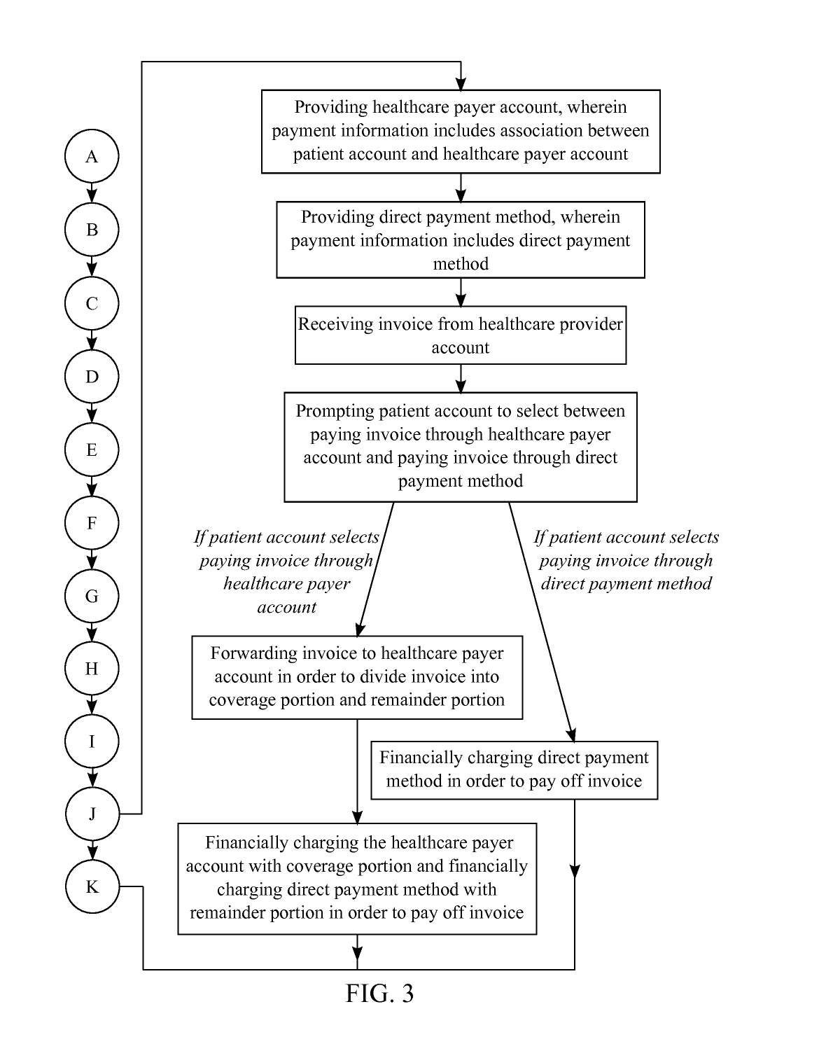

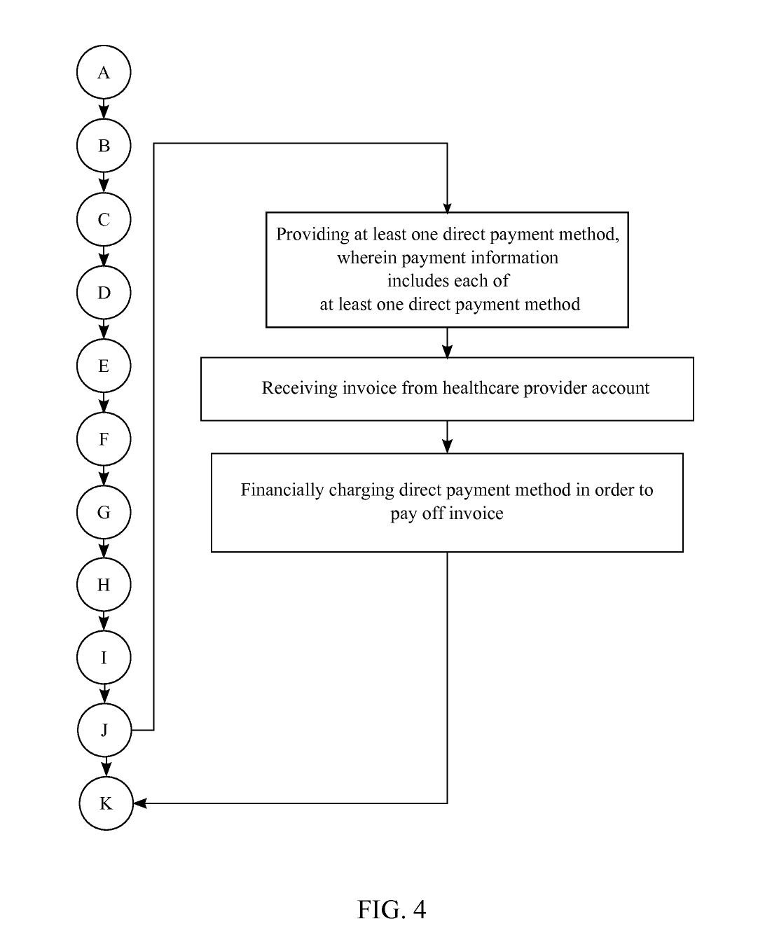

In the process of financially charging the patient account for the services rendered by the healthcare provider account, the present invention initially receives an invoice from the healthcare provider account. The invoice notifies the present invention that the health provider completed providing service to the patient account. As illustrated in FIG. 3 and FIG. 4, when the present invention receives the invoice, the patient account is prompted to select between paying the invoice through the healthcare payer account and paying the invoice through the direct payment method. If the patient account decides to utilize the healthcare payer account to pay the invoice, the invoice is forwarded to the healthcare payer account. When the healthcare payer account receives the invoice, the invoice is divided into a coverage portion and a remainder portion. More specifically, the coverage portion is the amount of the invoice that is covered by the healthcare plan provided to the patient account by the healthcare payer, who can be, but is not limited to, a health insurance company or an employer. Moreover, the remainder portion is the amount of the invoice that is to be paid by the patient account. When the coverage portion and the remainder portion are determined, the healthcare payer account is financially charged with the coverage portion. Next, the direct payment method is charged with the remainder portion of the invoice in order to pay off the invoice.

As illustrated in FIG. 3, the patient account can determine the invoice to be paid fully through the direct payment method as well. Similar to the previous instance, the patient account is prompted to select between paying the invoice through the healthcare payer account and paying the invoice through the direct payment method. However, the patient account can allow the present invention to financially charge only the direct payment method when paying off the invoice. As a result, the healthcare payer account is not charged in the process of paying off the invoice and the total financial charge is covered by the direct payment method.

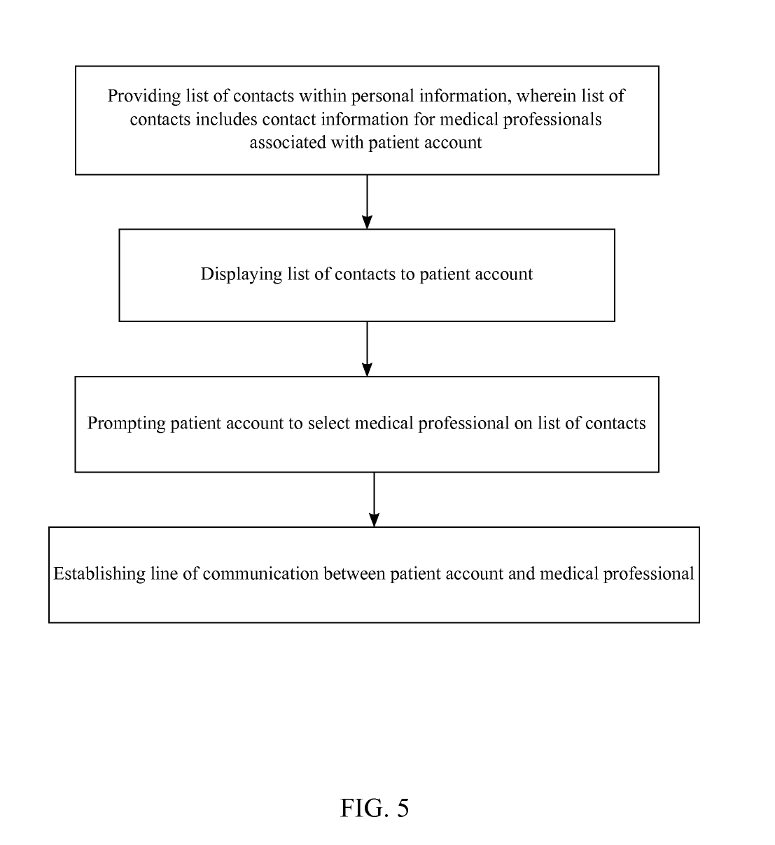

The present invention can also be utilized when the healthcare payer account is not provided. Similar to the previous instances, the present invention initially receives the invoice from the healthcare provider account. However, since the healthcare payer account is non-existent, the patient account allows the present invention to financially charge the direct payment method. The process of paying off the invoice when the healthcare payer account is non-existent is illustrated in FIG. 5.

In utilizing the present invention the following process flow is followed. Initially, the patient or their designee uploads information to the secure server through the patient account. More specifically, the patient account uploads the personal information, the medical history, and the payment information through the patient account. The personal information, the medical history, and the payment information are accessible to the healthcare provider account. However, the healthcare provider account can only edit and update the medical history. In order to access the personal information and the medical history, the healthcare provider account reads the information retrieval point on the physical access card. The information retrieval point can be either scanned through the mobile application or the numerical code of the information retrieval code can be entered onto the healthcare provider interface. When the information retrieval point is successfully processed, the personal information and the medical history are displayed to the healthcare provider account through the healthcare provider interface. After the healthcare provider account provides services to the patient account or completes updating the medical history of the patient, the present invention receives the medical examination results for the patient account from the healthcare provider account. Next, the medical history of the patient account is modified with the medical examination results. When the present invention receives the invoice from the healthcare provider account for the services provided to the patient account, the patient account is charged accordingly. More specifically, the invoice for the services is either paid off through the healthcare payer account and the direct payment method or just through the direct payment method.

Although the invention has been explained in relation to its preferred embodiment, it is to be understood that many other possible modifications and variations can be made without departing from the spirit and scope of the invention as hereinafter claimed.

What is claimed is:

1. A method for accessing medical and financial information comprises the steps of:
providing a patient account and a healthcare provider account;
prompting the patient account to enter personal information, medical history, and payment information through a user interface;
storing the personal information, the medical history, and the payment information on at least one secure server;
embedding the personal information, the medical history, and the payment information onto a physical access card;
embedding the physical access card with at least one information retrieval point;
prompting the healthcare provider account to read the information retrieval point on the physical access card;
accessing the personal information, the medical history, and the payment information after processing the information retrieval point for the healthcare provider account;
displaying the personal information and the medical history to the healthcare provider account through an examiner interface;
receiving medical examination results for the patient account from the healthcare provider account;
modifying the medical history of the patient account with the medical examination results; and
financially charging the patient account with options provided by the payment information.

2. The method for accessing medical and financial information as claimed in claim 1, wherein the user interface is a mobile application.

3. The method for accessing medical and financial information as claimed in claim 1, wherein the healthcare provider interface is a mobile application.

4. The method for accessing medical and financial information as claimed in claim 1 further comprises the steps of:
prompting the patient account to read the information retrieval point on the physical access card;
accessing the personal information, the medical history, and the payment information after processing the information retrieval point for the patient account; and
displaying the personal information, the medical history, and the payment information to the patient account through the user interface.

5. The method for accessing medical and financial information as claimed in claim 4 further comprises the steps of:
providing a list of contacts within the personal information, wherein the list of contacts includes contact information for medical professionals associated with the patient account;
displaying the list of contacts to the patient account;
prompting the patient account to select a medical professional on the list of contacts; and
establishing a line of communication between the patient account and the medical professional.

6. The method for accessing medical and financial information as claimed in claim 1 further comprises the steps of:
providing a healthcare payer account, wherein the payment information includes an association between the patient account and the healthcare payer account;
providing at least one direct payment method, wherein the payment information includes each of the at least one direct payment method;
receiving an invoice from the healthcare provider account;
prompting the patient account to select between paying the invoice through the healthcare payer account and paying the invoice through the direct payment method;
forwarding the invoice to the healthcare payer account in order to divide the invoice into a coverage portion and a remainder portion, if the patient account selects paying the invoice through the healthcare payer account; and
financially charging the healthcare payer account with the coverage portion and financially charging the direct payment method with the remainder portion in order to pay off the invoice.

7. The method for accessing medical and financial information as claimed in claim 1 further comprises the steps of:
providing a healthcare payer account, wherein the payment information includes an association between the patient account and the healthcare payer account;
providing at least one direct payment method, wherein the payment information includes each of the at least one direct payment method;
receiving an invoice from the healthcare provider account;
prompting the patient account to select between paying the invoice through the healthcare payer account and paying the invoice through the direct payment method; and
financially charging the direct payment method in order to pay off the invoice, if the patient account selects paying the invoice through the direct payment method.

8. The method for accessing medical and financial information as claimed in claim 1 further comprises the steps of:
providing at least one direct payment method, wherein the payment information includes each of the at least one direct payment method;
receiving an invoice from the healthcare provider account; and
financially charging the direct payment method in order to pay off the invoice.

9. The method for accessing medical and financial information as claimed in claim 1, wherein the information retrieval point is a magnetic strip.

10. The method for accessing medical and financial information as claimed in claim 1, wherein the information retrieval point is a quick response code.

11. The method for accessing medical and financial information as claimed in claim 1, wherein the information retrieval point contains a numerical code.
